(19) United States
(12) Patent Application Publication
(10) Pub. No.: US 2021/0137316 A1
(43) Pub. Date: May 13, 2021

(54) A SHEARING BLENDER

(71) Applicant: Breville Pty Limited, Alexandria (SE)

(72) Inventors: Duncan Bruce Hellmers, New South Wales (AU); Stephen John McClean, New South Wales (AU)

(21) Appl. No.: 17/057,623

(22) PCT Filed: May 22, 2019
(86) PCT No.: PCT/AU2019/050498

§ 371 Date: Nov. 20, 2020

(30) Foreign Application Priority Data
May 22, 2018 (AU) 2018901792

(51) Int. Cl. A47J 43/07; A47J 43/046; B02C 18/18

(52) U.S. Cl. CPC A47J 43/0722; B02C 18/186; A47J 43/046

(57) ABSTRACT

A container assembly (50) for a food processor. The container assembly (50) includes a container (10) having a bowl (11) within which there is located a blade assembly (19). The blade assembly (19) includes a stationary blade (34) and a rotatably blade (35) with food being engaged by the blade (35), in cooperation with the blade (34) to cut the food. Additionally the container assembly (50) may include a container (10) having a concave bowl (11) within which there is a plurality of upward facing ribs (23).

### FIELD

The present invention relates to food processors, and more particularly, but not exclusively to blenders.

### BACKGROUND

Blenders consist of a container that receives food to be processed, with a blade array at the lower end of the container that is rotatably driven. The blades engage the food product and cut the food product.

In order to cut the food product, the blades are rotatably driven at reasonably high speeds.

Disadvantages of the above described food processors are vibration and noise, generated as a result of the speed at which the blade array is rotated. Additionally, the high speeds result in accelerated wear on the moving parts.

A further disadvantage of the above described food processors is that rotation of the blade assembly causes the contents with the container to rotate with the blade array, thereby reducing the relative speed between the food being processed and the blade array. The reduction in this relative speed detracts from the efficiency of operation of the food processor.

A still further disadvantage is that food being processed rotates with the blade, causing a vortex in the centre of the container into which air is drawn that is mixed with the food being processed. This mixing of air with the food being processed exacerbates problems in respect of oxidation of the food.

Disclosed in U.S. Pat. No. 1,796,278 and DE 1037088, are blenders/mixers that include a hollow container that receives a food product to be processed, with the container having a bottom floor within which there is mounted a rotatably driven blade assembly. The food processors of these two documents have one or more of the above disadvantages,

### Object

It is the object of the present invention to overcome or substantially ameliorate at least one of the above disadvantages.

### SUMMARY OF INVENTION

There is disclosed herein a food processor container assembly including:

a container to receive food to be processed, the container having a generally central upright longitudinal axis, a bottom bowl with a concave upwardly facing surface, and a side wall extending upwardly from the bowl, with the bowl and side wall at least partly enclosing a chamber within which the food is processed, the container further including a plurality of ribs extending from said surface towards said axis;

a driven shaft extending through the bowl and along said axis, the shaft being rotatably driven about said axis; and

a blade array located in the bowl and fixed to the shaft so as to rotate therewith about said axis, the blade array including a plurality of blades that extend outward relative to said axis so as to have a direction of extension that includes a radial component and an axial component; and wherein at least one of the blades has a clearance, relative to at least one of said ribs, of 0.5 mm to 5.00 mm.

Preferably, the upwardly facing surface is concave.

Preferably, the clearance is 1.5 mm to 2.5 mm.

Most preferably the clearance is about 2 mm.

Preferably, each of the ribs has an edge portion, with the clearance existing between the edge portions and each of the blades.

Preferably, the edge portion extends relative to said axis so as to have a radial component of extension, and an axial component of extension.

Preferably, each edge portion further has a direction of extension component angularly relative to said axis.

In an alternative preferred form, the blades are generally straight.

Preferably, each blade is curved.

Preferably, each blade, when adjacent a respective one of the edge portions, is inclined thereto by an acute angle.

Preferably, the blade array is rotated in an angular direction, with each rib having a leading arcuate surface, and a trailing arcuate surface relative to said angular direction, with the arcuate surfaces converging to a respective one of the edge portions.

Preferably, the blade array includes first blades and second blades, with said first blade each having said clearance, and second blades, spaced radially inwardly from the first blades, with the first blades being configured to shear (slice) the food, and the second blade being configured to cut the food.

There is further disclosed herein a food processor container assembly including:

a container to receive food to be processed, the container having a generally central upright longitudinal axis, a bottom bowl with an upwardly facing surface, and a side wall extending upwardly from the bowl, with the bowl and side wall at least partly enclosing a chamber within which the food is processed;

a driven shaft extending through the bowl and along said axis, the shaft being rotatably driven about said axis; and a blade array located in the bowl, the blade array including a first blade that is fixed to the shaft so as to be driven thereby about said axis, and a second blade fixed with respect to the bowl so as to be stationary, each of the blades including a plurality of blade tips extending outwardly relative to said axis, with the first blade being located adjacent the second blade so that movement of the first blade pass the second blade result in size reduction of the food being processed.

Preferably, the first blade is above the second blade.

Preferably, the second blade is generally planar.

Preferably, the tips of the first blade are arcuate so as to extend outwardly and upwardly away from said axis.

Preferably, the first blade tips include first tips and second tips, with the first tips and second tips being alternately arranged about said axis, with the first tips including a leading cutting edge to engage the food.

Preferably, each of the first blades tips has a leading edge, with at least some of the leading edges being configured to shear (slice) the food, while at least some of the leading edges are configured to cut the food.

A food processor including the container assembly of any one of claims 1 to 18.

### BRIEF DESCRIPTION OF DRAWINGS

Preferred forms of the present invention will now be described by way of example with reference to the accompanying drawings wherein:

FIG. 1 is a schematic vertically sectioned isometric view of a food processor container;

FIG. 2 is a schematic sectioned isometric view of the bowl portion of the container of FIG. 1;

FIG. 3 is a schematic sectioned isometric view of a modification of the bowl portion of FIG. 2;

FIG. 4 is a schematic top plan view of the bowl portion of FIG. 2;

FIG. 5 is a schematic top plan view of the bowl portion of FIG. 3;

FIG. 6 is a schematic enlarged view of portion of the bowl as shown in FIG. 4;

FIG. 7 is a schematic enlarged isometric view of portion of the bowl as shown in FIG. 5;

FIG. 8 is a schematic sectioned isometric view of a modification of the bowl of FIG. 2;

FIG. 9 is a schematic sectioned isometric view of a modification of the bowl of FIG. 3;

FIG. 10 is a schematic sectioned side elevation of a food processor container having a bowl modification of FIG. 9;

FIG. 11 is a schematic sectioned side elevation of a further food processor container;

FIG. 12 is a schematic sectioned side elevation of the bowl portion of the container of FIG. 10;

FIG. 13 is a schematic isometric view of a blade array of the container of FIG. 10; and

FIG. 14 is a schematic parts exploded isometric view of the blade array of FIG. 13.

### DESCRIPTION OF EMBODIMENTS

In FIG. 1 there is schematically depicted the container assembly 10 of a food processor. Typically the container assembly 10 would be mounted on a motor 51 (FIG. 10) contained in a base 52 with a drive shaft engaged by the container assembly 10.

The container assembly 10 includes an upper hollow body 50, a bowl 11, below the body 50, that provides a concave upwardly facing surface 12.

Fixed to and extending upwardly from the bowl 11, and provided by the body 50, is a side wall 13 that is selectively closed at its upper end by means of a lid 14.

The bowl 11, side wall 13 and lid 14 enclose a chamber 15 within which food is to be processed. The chamber 15 includes a sub-chamber 31 (as shown in FIG. 2) contained in the bowl 11.

The container assembly 10 has a generally upright central longitudinal axis 16, while the side wall 13 has an internal surface 17.

Extending through the bowl 11 is a driven shaft 18 that is rotatably driven about the axis 16 by a motor located in the base of the food processor.

Fixed to an upper portion of the shaft 18 is a blade array 19 that includes a plurality of first blades 20 that slice the food and a plurality of second blades 21 that cut the food. The blade array 19 is contained in the sub-chamber 31. The blades 21 are located radially inward from the blades 20 towards the axis 16.

In the embodiment shown in FIGS. 1, 2, 4, 6 and 8, blades 20 are curved, and preferably extend outwardly from a central hub 22, that is fixed to an upper portion of the shaft 18 but adjacent the lower surfaces of the bowl 11. Each of the blades 20 and 21 is fixed to the hub 22 and rotates therewith about the axis 16.

The blades 21 are located generally centrally of the bowl 11 and are well spaced from the surface 12. Each of the blades 21 has a direction of extension, relative to the axis 16, that includes a radial component and a longitudinal component.

The blades 21 are angularly spaced about the axis 16, as are the blades 20.

The bowl 11 is also provided with a plurality of projections, that in this embodiment are ribs 23. The ribs 23 project inwardly towards the axis 16 from the surface 12 and are angularly spaced about the axis 16.

Each of the ribs 23 has an edge portion 24 that extends away from the axis 16, and has a direction of extension relative to the axis 16 that includes a radial component and an axial component.

The blades 20 when rotating come close to the edge portions 24 so as to shear the food product contained in the chamber 17. In particular, there is a clearance 25 between the blades 20 and end portions 24. The clearance 25 is 0.5 mm to 5.00 mm, most preferably 1.5 mm to 2.5 mm, and most preferably about 2 mm.

The shaft 18 is rotated at a speed dependent on the desired food result. Preferably, the shaft 18 is rotated at an angular velocity of at least about 3,000RPM, in the direction 26.

The ribs 23 (and therefore the edge portion 24) may extends radially from the axis 16, or alternatively may extend from positions offset from the axis 16, as best seen in FIG. 4.

In this embodiment the blades 20 extend radially from the axis 16, however it should be appreciated that they may also be offset, and may extend not only radially, but may be curved so as to extend radially and angularly relative to the axis 16. Additionally, the blades 20 may be curved as best seen in FIGS. 1 and 2, that is they may have a component direction of extension in the direction of the axis 16, or alternatively they may be linear.

As best seen in FIG. 4, preferably the blades 20 approach and pass the edge portions 24 at an acute angle 27.

As seen in FIG. 2, the ribs 23 have a leading surface 27 and a trailing surface 28 that extend from the surface 12 to the edge portion 24. The surfaces 27 and 28 are concave.

In the embodiment shown in FIGS. 3, 5, 7 and 9, each blade 20 includes a stem 29 that is fixed to the shaft 18 and extends radially outwardly therefrom to a blade tip 30. The blade tips 30 have their major direction of extension generally parallel to the axis 16. Accordingly, the blades 20 have a direction of extension radially and axially relative to the axis 16. The hub 22 is spaced from the lower surfaces of the bowl 11.

The ribs 23 extend inwardly towards the axis 16 from the surface 12 so that the edge portions 24 have their major direction of extension generally parallel to the axis 16. A clearance 25, as described previously, is provided between the edge portions 24 and the blade tips 30.

In respect of this embodiment, the edge portions 24 and blade tips 30 may also have a direction of extension angularly about the axis 16. Additionally, the edge portion 24 and tips 30 may be inclined to the axis 16, as opposed to being generally parallel thereto as shown in FIG. 3. In respect of this embodiment, as the hub 22 is spaced from the lower surfaces of the bowl, liquid is caused to move radially outward.

In the above described preferred embodiments the blades 20 are contained within the bowl 11, that is within the sub-chamber 31.

In the embodiments of FIGS. 8 and 9, the bowl 11 has a heating element 32 that is operable to heat the food being processed.

The above described preferred embodiment has a number of advantages, in particular the blades 20 passing the edge portions 24 so as to shear the food product, as opposed to cutting the food. This provides the advantage of producing smaller food particle sizes, consistently.

A further advantage is that a central vortex is created as the ribs 23 inhibit the food (and liquid), circulating about the axis 16. The ribs 23 also cause the rotational speed of the food particles to be different to the rotation speed of the blades 20 and 21. The rotational direction of the food particles may be opposite to the rotational direction. At low speed, the angular velocity and vertical velocity of the vortex is reduced.

The blades 21 rotate in the direction 26, causing liquid in lower portions of the bowl 11 to rise, creating a vortex 68 that rotates in a direction 49 opposite the direction 26 about the axis 16. This reverse direction of flow aids in shearing and cutting the food enhancing operation of the assembly 10.

A further advantage is that the ribs 23 cause the food product, contained in its liquid, to move upwardly relative to the axis 16, and then upon reaching an upper surface, the food being processed is turned downwardly so as to pass down adjacent the axis 16. This has the additional advantage of drawing little air into the food being processed, thereby ameliorating problems associated with oxidation.

In operation of the above embodiments, food is first processed by the blade 21 that cut/slice the food to provide portions of a smaller size. These smaller sized portions are processed by the blades 22 that shear the food.

In the embodiment of FIGS. 11 to 14, the bowl 11 may be provided with an upwardly facing surface 12 that is concave, in a similar manner to the previous embodiments, however the bowl 11 may have a generally planar upwardly facing surface 12 extending generally perpendicular to the axis 16, and a side wall portion 33 providing a generally cylindrical internal surface 44 having as its longitudinal axis, the axis 16.

In the embodiments of FIGS. 11 to 14, the blade array 19 includes a stationary blade 34 and rotatable blade 35. The blades 34 are fixed to a hub 36 that is threaded to provide for mounting in the bowl 11, and that provides a central longitudinal passage 37 through which the shaft 18 passes. The upper end of the shaft 18 is provided with a threaded passage 38 that receives a threaded fastener 39 to fix the rotatable blade 35 to the shaft 18.

The blade 34 is fixed to the mounting hub 36 by pins 40.

The stationary blade 34 may include at least two, and preferably three or four, blade tips 41 that extend outwardly from the axis 16, and are arranged angularly about the axis 16.

In this embodiment, the blade 34 is generally planar (flat) with first edges 42 and second edges 43. Each edge 42 of each tip 41 is laterally displaced relative the axis 16 and extends outwardly relative thereto so as to have a radial direction of extension and an angular direction of extension, while being generally straight. Each edge 45 of each tip 41 is also externally displaced from the axis 16 but extends outwardly therefrom, so as to have a radial direction of extension and an angular direction of extension, while preferably being straight. The edges 42 and 43, of each tip 41 converge radially outward. The edges 46 are sharper than the blunt edges 47. The edges 46 cut the food while the edges 47 slice the food.

The rotatably driven blade 35 has blade tips 44 and 45. The blade tips 44 and 45 are alternately arranged angular about the axis 16, with the blade tips 45 being generally located in a radial plane extending from the axis 16, while the tips 44 extends outwardly from the axis 16, also extend upwardly away from the blade 34 so as to be arcuate. Accordingly, the distance between the tips 44 and tips 41 increase radially outward. Preferably, each blade tip 44 has a leading (relative to the rotational direction 26) cutting edge 46, while each blade tip 44 has a generally flat blunt leading edge 47.

In operation of the blade assembly of the embodiment of FIGS. 11 to 14, the stationary blade 44 holds the food to be processed, while the rotating blade 45 engages the food in a guillotine fashion cutting the food in cooperation with the blade 34. The blade tips 44, by being upwardly curved, have the advantage of engaging food that may not have been engaged by the blade tips 45.

A further advantage of the above described preferred embodiment, is that the edges 46 cut the food.

In the embodiment of FIGS. 10 to 14, the bowl 11 may be provided with ribs 23.

1. A food processor container assembly including:
a container to receive food to be processed, the container having generally central upright longitudinal axis, a bottom bowl with a concave upwardly facing surface, and a side wall extending upwardly from the bowl, with the bowl and side wall at least partly enclosing a chamber within which the food is processed, the container further including a plurality of ribs extending from said surface towards said axis;
a driven shaft extending through the bowl and along said axis, the shaft being rotatably driven about said axis; and
a blade array located in the bowl and fixed to the shaft so as to rotate therewith about said axis, the blade array including a plurality of blades that extend outward relative to said axis so as to have a direction of extension that includes a radial component and an axial component; and wherein at least one of the blades has a clearance, relative to at least one of said ribs, of 0.5 mm to 5.00 mm.

2. The container assembly of claim 1, wherein the upwardly facing surface is concave.

3. The container assembly of claim 1, wherein the clearance is 1.5 mm to 2.5 mm.

4. The container assembly of claim 3, wherein the clearance is about 2 mm.

5. The container of claim 1, wherein each of the ribs has an edge portion, with the clearance existing between the edge portions and each of the blades.

6. The container of claim 5, wherein the edge portion extends relative to said axis so as to have a radial component of extension, and an axial component of extension.

7. The container of claim 5, wherein each edge portion further has a direction of extension component angularly relative to said axis.

8. The container of claim 6, wherein, the blades are generally straight.

9. The container of claim 1, wherein each blade is curved.

10. The container of claim 1, wherein each blade, when adjacent a respective one of the edge portions, is inclined thereto by an acute angle.

11. The container of claim 1, wherein the blade array is rotated in an angular direction, with each rib having a leading arcuate surface, and a trailing arcuate surface relative to said angular direction, with the arcuate surfaces converging to a respective one of the edge portions.

12. The container of claim 1, wherein the blade array includes first blades and second blades, with said first blade each having said clearance, and second blades, spaced radially inwardly from the first blades, with the first blades being configured to shear (slice) the food, and the second blade being configured to cut the food.

13. A food processor container assembly including:
a container to receive food to be processed, the container having a generally central upright longitudinal axis, a bottom bowl with an upwardly facing surface, and a side wall extending upwardly from the bowl, with the bowl and side wall at least partly enclosing a chamber within which the food is processed;
a driven shaft extending through the bowl and along said axis, the shaft being rotatably driven about said axis; and
a blade array located in the bowl, the blade array including a first blade that is fixed to the shaft so as to be driven thereby about said axis, and a second blade fixed with respect to the bowl so as to be stationary, each of the blades including a plurality of blade tips extending outwardly relative to said axis, with the first blade being located adjacent the second blade so that movement of the first blade pass the second blade result in size reduction of the food being processed.

14. The container assembly of claim 13, wherein the first blade is above the second blade.

15. The container assembly of claim 13, wherein the second blade is generally planar.

16. The container assembly of claim 13, wherein the tips of the first blade are arcuate so as to extend outwardly and upwardly away from said axis.

17. The container assembly of claim 13, the first blade tips include first tips and second tips, with the first tips and second tips being alternately arranged about said axis, with the first tips including a leading cutting edge to engage the food.

18. The food processor of claim 13, wherein each of the first blades tips has a leading edge, with at least some of the leading edges being configured to shear (slice) the food, while at least some of the leading edges are configured to cut the food.

19. A food processor including the container assembly of claim 1.
